(19) United States
(12) Patent Application Publication
(10) Pub. No.: US 2023/0097836 A1
(43) Pub. Date: Mar. 30, 2023

(54) CORRECTION APPARATUS, SYSTEM, METHOD, AND PROGRAM FOR CORRECTING MOTION ARTIFACTS

(71) Applicant: Rigaku Corporation, Tokyo (JP)

(72) Inventor: Takumi OTA, Tokyo (JP)

(73) Assignee: Rigaku Corporation, Tokyo (JP)

(21) Appl. No.: 17/947,203

(22) Filed: Sep. 19, 2022

(30) Foreign Application Priority Data
Sep. 29, 2021 (JP) 2021-159126

(51) Int. Cl. G06T 11/00; G06T 5/00

(52) U.S. Cl. CPC G06T 11/008; G06T 5/003; G06T 11/005; G06T 2207/10081

(57) ABSTRACT

Correcting artifacts by motion according to reconstruction of a CT image includes circuitry configured to acquire a projection image of 360-degree scanning; calculate a motion amount using parameters by setting a motion model including the parameters; calculate a relative motion amount of a projection data from the projection data of the projection image and opposite data thereto; prepare a fixed-point equation including the motion amount and the relative motion amount; determine the parameters in the motion model by self-consistently solving the fixed-point equation; and correct the projection image using the motion amount.

### CROSS-REFERENCES TO RELATED APPLICATIONS

The present application claims priority to Japanese Patent Application 2021-159126, filed Sep. 29, 2021, the entire contents of each of which are incorporated herein by reference.

### BACKGROUND

### Field

The present disclosure relates to a correction apparatus for correcting artifacts, and to a system, a method and a program therefor.

### Description of the Related Art

A computed tomography (CT) apparatus reconstructs a CT image from a plurality of projection images acquired while rotating a sample or a gantry. According to the CT apparatus, it is called motion when the sample or an optical system moves during measurement. When reconstruction is carried out without correcting the projection images where motion occurs, blurs and streak-like artifacts are generated on the reconstructed CT image. Thus, the reconstructed image does not precisely reflect a sample shape, thereby losing a quantitative property.

In order to reduce artifacts caused by such motion, photographing into which apparatuses other than the CT apparatus are introduced, devising of photographing methods, and corrections made by software have been performed in a conventional manner. In Patent Document 1, disclosed is a technique of correcting a projection image acquired by CT scanning by acquiring three-dimensional position information using a belt-like laser in order to provide simply and easily photographable CT photographing method and apparatus without strongly positioning an examinee, while reducing motion artifacts due to body motion of the examinee during CT photographing.

In Non-Patent Document 1, disclosed is a technique in which normal scanning is performed the first time, and rough and quick scanning is performed the second time, assuming that there is no motion during the second time quick scanning, the technique of correcting a projection image acquired by the first time measurement based on the projection image acquired by the second measurement. In Non-Patent Document 1, further disclosed is a technique of precisely and gradually estimating the motion during repetition of the projection and the back projection. In Non-Patent Document 2, disclosed is a technique in which absolute motion which a reconstructed image obtained by correcting with has the largest sharpness is considered as actual motion, by determining relative motion using opposite data, and preparing some kinds of the absolute motion estimated from the relative motion.

### Patent Document

[Patent Document 1] Japanese Patent No. 6761642

### Non-Patent Documents

[Non-Patent Document 1] Developments in X-Ray Tomography VI, edited by Stuart R. Stock, Proc. of SPIE Vol. 7078, 70781C, (2008)⋅0277-786X/08/$18⋅doi: 10.1117/12.793212 “Compensation of mechanical inaccuracies in micro-CT and nano-CT”
[Non-Patent Document 2] Journal of X-Ray Science and Technology 25 (2017) 927-944 DOI 10.3233/XST-16231 IOS Press “Translational motion correction algorithm for truncated cone-beam CT using opposite projections”

### SUMMARY

However, as to the technique disclosed in Patent Document 1, special apparatuses such as a laser, a sensor and so forth need to be introduced, and thus introduction cost is required. A technique of performing measurements twice among techniques disclosed in Non-Patent Document 1 exhibits motion that is still remaining, even it being quickly measured. For example, the motion or the like based on tolerance errors caused by a rotation axis cannot be corrected. Further, measurements must be made twice, thereby requiring much time for measurement. According to a technique of iteratively estimating the motion among the techniques disclosed in Non-Patent Document 1, the projection and the back projection calculation need to be repeated, thereby requiring calculation cost. As to the technique disclosed in Non-Patent Document 2, reconstruction is required by combinations of a number of different kinds of motion, thereby requiring calculation cost. Further, actual motion cannot often be known from relative motion.

The present disclosure has been made in view of such a situation, and it is an object to provide a correction apparatus capable of reducing cost for correcting artifacts by motion according to reconstruction of a CT image, and to provide a system, a method and a program therefor.

(1) In order to achieve the above-described object, it is a feature that the correction apparatus according to the present disclosure is a correction apparatus for correcting artifacts by motion during measurement of a CT image, the correction apparatus comprising a projection image acquisition section that acquires a projection image of 360-degree scanning; a motion amount calculation section that calculates a motion amount using parameters by setting a motion model including the parameters; a relative motion amount calculation section that calculates a relative motion amount of a projection data from the projection data of the projection image and opposite data thereto; a fixed-point equation preparation section that prepares a fixed-point equation including the motion amount and the relative motion amount; a motion estimation section that determines the parameters in the motion model by self-consistently solving the fixed-point equation; and a correction section that corrects the projection image using the motion amount.

(2) Further, it is a feature that in the correction apparatus according to the present disclosure, the projection image is an image obtained by a fan beam, and the relative motion amount is found by the projection data that is fan/parallel-converted, and the opposite data thereto.

(3) Further, it is a feature that in the correction apparatus according to the present disclosure, the motion model is a model for expressing at least one or more of translation of a sample rotation axis on a detector plane or rotation around a certain axis.

(4) Further, it is a feature that in the correction apparatus according to the present disclosure, the motion model is expressed by a finite-order polynomial in which a rotation angle oi the sample rotation axis is a variable.

(5) Further, it is a feature that in the correction apparatus according to the present disclosure, the motion estimation section determines the parameters in the motion model based on the predetermined number of repetition times.

(6) Further, it is a feature that in the correction apparatus according to the present disclosure, the motion estimation section determines the parameters in the motion model based on a predetermined threshold value.

(7) Further, it is a feature that in the correction apparatus according to the present disclosure, calculation of the relative motion amount is carried out, based on an area of part of the projection data.

(8) Further, it is a feature that the correction apparatus according to the present disclosure comprises a reconstruction section that generates the CT image by performing reconstruction based on the projection image corrected by the correction section, and a display section that displays the CT image on a display device.

(9) Further, it is a feature that a system according to the present disclosure comprises a CT apparatus, and the correction apparatus according to any one of the above-described (1) to (8), wherein the CT apparatus comprises an X-ray source that generates X-rays, a detector that detects the X-rays, and a rotation control unit that controls rotation of a sample or the X-ray source and the detector.

(10) Further, it is a feature that the method according to the present disclosure is a method for correcting artifacts by motion during measurement of a CT image, the method comprising the steps of acquiring a projection image of 360-degree scanning; calculating a motion amount using parameters by setting a motion model including the parameters; calculating a relative motion amount of a projection data from the projection data of the projection image and opposite data thereto; preparing a fixed-point equation including the motion amount and the relative motion amount; determining the parameters in the motion model by self-consistently solving the fixed-point equation; and correcting the projection image using the motion amount.

(11) Further, it is a feature that the program according to the present disclosure is a program for correcting artifacts by motion during measurement of a CT image, that causes a computer to execute the processes of acquiring a projection image of 360-degree scanning; calculating a motion amount using parameters by setting a motion model including the parameters; calculating a relative motion amount of a projection data from the projection data of the projection image, and opposite data thereto; preparing a fixed-point equation including the motion amount and the relative motion amount; determining the parameters in the motion model by self-consistently solving the fixed-point equation; and correcting the projection image using the motion amount.

### BRIEF DESCRIPTION OF THE DRAWINGS

FIGS. 1A and 1B are schematic diagrams showing an axis associated with motion, and movement thereof, respectively (a diagram viewed from a sample rotation axis direction, and a projection diagram viewed from an X-ray source).

FIGS. 2A and 2B are schematic diagrams showing projection data at rotation angle θ of a sample rotation axis when motion occurs, and opposite data thereto, respectively.

FIGS. 3A and 3B are schematic diagrams showing a sinogram of actually measured data and a sinogram after temporary correction and fan/parallel-conversion, respectively.

FIG. 4 is a schematic diagram showing one example of a configuration of the whole system.

FIG. 5 is a schematic diagram showing a modified example of a configuration of the whole system.

FIG. 6 is a block diagram showing one example of a configuration of a processing apparatus and a correction apparatus.

FIG. 7 is a block diagram showing a modified example of a configuration of a processing apparatus and a correction apparatus.

FIG. 8 is a block diagram showing another modified example of a configuration of a processing apparatus and a correction apparatus.

FIG. 9 is a conceptual diagram showing one example of UI when a user performs various kinds of setting.

FIG. 10 is a flowchart showing one example of an operation of a correction apparatus.

FIG. 11 is a flowchart showing a modified example of an operation of a correction apparatus.

FIG. 12 is a flowchart showing one example of an operation of a system.

FIGS. 13A and 13B are a CT image of sample 1, that is reconstructed using a projection image that is not corrected; and another CT image of the sample 1, that is reconstructed using a projection image that is corrected, respectively.

FIGS. 14A and 14B are a CT image of sample 2, that is reconstructed using a projection image that is not corrected; and another CT image of the sample 2, that is reconstructed using a projection image that is corrected, respectively.

### DETAILED DESCRIPTION

Next, embodiments of the present disclosure are described referring to the drawings. In order to facilitate understanding of the description, reference number indicating the same constituent element is used as same and overlapping descriptions are omitted in each drawing.

### [Principle]

A sample is irradiated with X-rays of a parallel beam, a fan beam or a cone beam from every angle by a CT apparatus to acquire a distribution of an absorption coefficient of X-rays, that is, a projection image by a detector. In order to irradiate X-rays thereto from every angle, the CT apparatus is constituted in such a manner that a sample stage is rotated with respect to a fixed X-ray source and a detector, or a gantry obtained by integrating a X-ray source and a detector is rotated.

In this manner, a distribution of a linear absorption coefficient of a sample can be estimated by shade of the projection image of the resulting sample by performing projection from various angles. Then, finding a three-dimensional linear absorption coefficient distribution from a two-dimensional projection image is called reconstruction. Reconstruction is basically performed by back projection of a projection image.

It is called motion when a sample or an optical system moves during measurement. Examples of causes of the motion include thermal drift, focus movement, tolerance errors, poor fixing of a sample, and so forth. When reconstruction is carried out without correcting the projection images where motion occurs, blurs and streak-like artifacts are generated on the reconstructed CT image. Such artifacts are called artifacts caused by motion. When the artifacts caused by the motion are generated, the reconstructed image does not precisely reflect a sample shape, thereby losing a quantitative property.

Conventionally, photographing into which apparatuses other than the CT apparatus are introduced, devising of photographing methods, and corrections made by software have been performed in order to suppress artifacts caused by such motion. For example, there is a correction method using three-dimensional position information measured by introducing special apparatuses such as a laser, a sensor and so forth into a CT apparatus. In this case, introduction cost is required.

As devising of the photographing methods, there is a method of measuring precisely the first time, measuring quickly the second time, and correcting the projected image measured the first time based on the projected image measured the second time (reference scanning measurement). However, much time is required for the measurement. Further, the rotation axis rotates irrespective of measuring time, and thus motion due to tolerance errors caused by the rotation axis cannot be corrected by such a method.

Further, as to corrections carried out by software, the corrections are made by performing image processing. For example, there are provided a method for making corrections by estimating motion using an iterative method, and a method in which an index searches for the best motion by performing reconstructions multiple times, assuming the motion. However, calculation cost is inevitably required for both of them, thereby producing a practical problem.

According to the present disclosure, the motion is estimated by preparing a fixed-point equation including a motion amount and a relative motion amount with respect to a projection image of 360-degree scanning to self-consistently solve the fixed-point equation, and corrections are made using the motion amount. Thus, special apparatuses such as a laser, a sensor and so forth do not need to be introduced, thereby being able to reduce introduction cost. Further, the correction is made for the projection image, thereby being able to reduce calculation cost. Accordingly, processing can be performed from measurement in a very short period of time to acquisition of a CT image, compared with conventional methods. The correction that is made according to the present disclosure means that with respect to the kind of assumed motion and a given movement amount coordinate values of CU, CV, and θ of a sinogram are converted by an amount equivalent to the movement amount by a method according to the kind of motion.

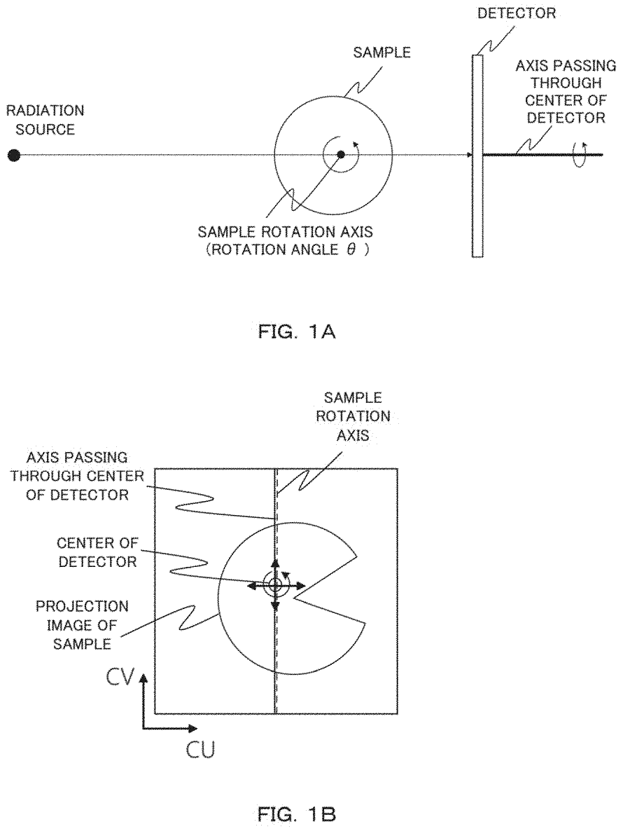

Assuming that the motion is translation of a sample rotation axis on a detector plane, of rotation around a certain axis, the motion model is preferably a function for which rotation angle θ of the sample rotation axis is represented as a variable. Herein, the certain axis means either an in-plane rotation axis of a detector or a sample rotation axis. However, it is possible not to be rotation of a sample rotation axis, but to be rotation of a rotation axis of an apparatus depending on how to conduct an apparatus (measurement). The rotation angle is relative, and thus the rotation angle of a rotation axis of the apparatus is also applicable to the present disclosure as a variable. FIGS. 1A and 1B are schematic diagrams showing an axis associated with motion, and movement thereof, respectively. Examples of kinds of motion include rotation around a sample rotation axis as shown in FIG. 1A, translation of a sample rotation axis as shown in FIG. 1B (in CU direction, in CV direction), and rotation around in-plane rotation axis of a detector. The present disclosure is directed to the above-described motion as correction targets. The motion correction can be made via processing of only the projection image by self-consistently solving a fixed-point equation regarding parameters in the motion model, and thus high-speed processing becomes possible.

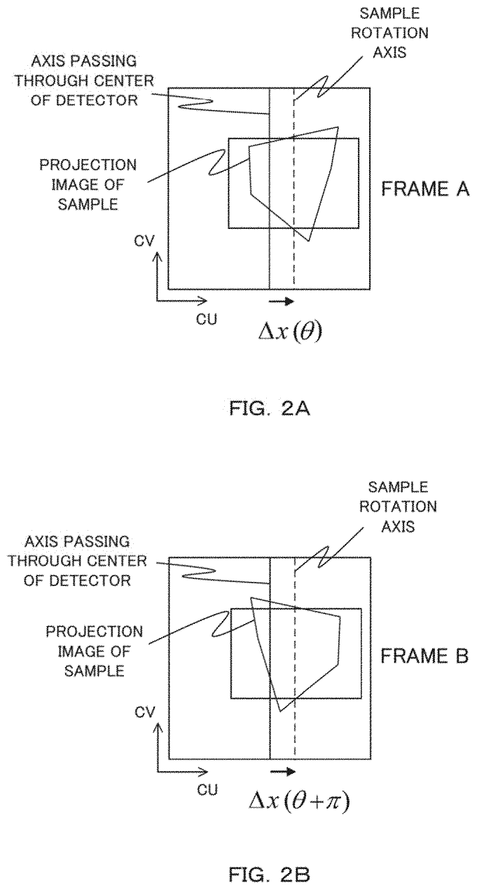

FIGS. 2A and 2B are schematic diagrams showing projection data at rotation angle θ of a sample rotation axis when motion whose sample rotation axis is translated in CU direction is generated, and opposite data thereto, respectively. Concerning an actual projection image, no position of a sample rotation axis is detected, but the rotation axis is described for the sake of convenience. In the example of FIG. 2, according to a projection image of each rotation angle θ, a difference between a sample rotation axis and an axis passing through a center of a detector can be represented by a motion amount Δx(θ). A motion amount according to opposite data to the projection image is represented by Δx(θ+π). When there are translation in CV direction, and in-plane rotation of a detector, a model may be formed, assuming each motion. A relative motion amount is a relative movement amount determined from data of a projection image at rotation angle θ+π (a projection image becoming paired in 180-degree rotation angle difference of a sample rotation axis) that is opposed to data of a projection image at rotation angle θ. The relative motion amount r(θ) at the rotation angle θ can be expressed by the following formula (1).

r(θ)=Δx(θ+π)−Δx(θ) (1)

According to calculation of a relative motion amount, the calculation may be carried out by limiting to an area of part of projection data of a projection image and another area of part of opposite data thereto. Thus, calculation cost required for calculation of the relative motion amount can be reduced. FIG. 2 shows a situation of calculating the relative motion amount from a matching degree between an inside of frame A and an inside of frame B by setting the frame A in FIG. 2A, and the frame B in FIG. 2B.

According to the relative motion amount, a frame matching degree set to a projection image at rotation angle θ+π of a sample rotation axis, that is opposed to data of a projection image at rotation angle θ of the sample rotation axis is preferably determined as an index. A movement amount of a frame whose frame matching degree becomes highest is calculated by changing how to move a frame set on a projection image, according to the kind of assumed motion. This movement amount can be set as the relative motion amount r(θ).

The projection image cannot be directly corrected from the relative motion amount. Further, the motion amount cannot be also directly found from the projection image. On the other hand, if what kind of function the motion model represents is found, the motion amount can be calculated, and thus the projection image can be corrected using the foregoing. The motion model means a function from which the motion amount at a rotation angle of each of all the sample rotation axes can be found. Herein, for example, when setting the motion model, assuming motion whose sample rotation axis is translated in CU direction, one obtained by adding a relative motion amount r(θ) to a motion amount Δx(θ) at rotation angle θ of a certain sample rotation axis determined from the motion model can estimate a motion amount d(θ+π) at rotation angle (θ+π) of a sample rotation axis opposed thereto, that is determined from the motion model. This relationship can be represented by the following formula (2).

d(θ+π)=Δx(θ)+r(θ) (2)

In order to determine parameters in the motion model, an equation concerning a finite number of parameters (fixed-point equation) is set. Calculating d(θ+π) with respect to a plurality of angles θ is performed, using the formula (2). A column vector obtained by arranging the calculated values in order is represented by D. A column vector obtained by arranging parameters in the motion model in order is represented by C; a matrix using a coefficient of each parameter at rotation angle (θ+π) of a sample rotation axis in the motion model as an element is represented by A; and an equation is set up in such a manner that their product becomes D. This equation is represented by the following formula (3).

D=AC (3)

Since D is a function of C, the formula (3) can be regarded as a fixed-point equation in which C represents a fixed point. This is self-consistently solved to find C. For example, C can be repetitively found. Repetitively finding C means that C is estimated with respect to C assumed in the kth step, using the above-described equation. It means to repeat the process of estimating C from the above-described equation, assuming this to be C in the k+1th step. Specifically, a parameter C in the motion model on the left-hand side D is made to be Cₖ to give numerical values; Cₖ₊₁ is determined, assuming it to be undetermined that the parameter C in the motion model on the right-hand side AC is made to be Cₖ₊₁; and a solution thereof can be found by a method of using this as a parameter C on the left-hand side D again. In addition, the method of self-consistently solving a fixed-point equation is not limited thereto.

The motion amount is calculated using a function in which C determined in this manner is applied to the motion model. The projection image can be corrected with the calculated motion amount as a correction amount. An image obtained by reducing artifacts by motion during measurement of a CT image can be acquired by reconstruction using a corrected projection image.

The correction method according to the present disclosure is described in detail as given below. The motion model is set, assuming that a sample rotation axis moves in CU direction and in CV direction by Δx(θ) and Δz(θ), respectively, with a detector origin as a reference, as given below. In this manner, the motion model is preferably a model for expressing at least one or more of translation of a sample rotation axis on a detector plane or rotation around the sample rotation axis or an in-plane rotation axis of the detector. Thus, it is facilitated to set the motion model.

According to the function representing the motion model, any kind of function may be used as long as motion can be appropriately expressed. When assuming that the sample rotation axis moves in CU direction and in CV direction by Δx(θ) and Δz(θ), respectively, with the detector origin as a reference, as described above, the motion is a function of the rotation angle θ of the sample rotation axis, and thus, for example, the motion model can be given by power series expansion relating to θ. In this case, the motion model that is actually set is preferably expressed by a finite-order polynomial in which a rotation angle of the sample rotation axis is a variable. In addition, for example, in cases where the motion vibrates, and so forth, the motion model may be given by Fourier series expansion. When there is no motion, Δx=0, and Δz=0 at an arbitrary angle.

When the motion model is represented by a finite-order polynomial in which a rotation angle θ of a sample rotation axis is a variable, for example, the motion model Δx(θ) is displayed as given by the following formula (4). Symbol deg means a degree of the motion model. The motion exhibits small movement, and thus the degree deg of the motion model is preferably a low degree. Thus, the number of parameters in the motion model can be reduced, thereby reducing cost required for processing. For example, the degree deg of the motion model can be set to 10 or less. Further, the motion Δz(θ) in CV direction, and rotation motion Δϕ(θ) around a certain axis can also be represented similarly to the formula (2).

$${Δ}_{X} ( θ ) = {\sum }_{n = 0}^{deg} {c}_{n} {θ}^{n} \qquad ( 4 )$$

Next, (θ+π) is substituted for a plurality of angles θ each in the formula (4), and plural pieces of those obtained by substituting d(θ+π) for left-handed sides of respective formulae are arranged and are represented by a matrix equation to obtain formula (5). Herein, the left-handed side, a column vector obtained by arranging parameters on the right-handed side and a matrix on the right-hand side correspond to D, C and A, respectively. The maximum value of a subscript of θ represents nₚ. Symbol nₚ represents the total projection number. The number of equations M of simultaneous equations is represented by the number of groups of opposite data used for motion estimation, and thus The maximum value of M becomes nₚ/2. The mth equation in the simultaneous equations is found by substituting one obtained by adding π to a projection angle selected to be the mth one, for (4). Further, elements in the matrix on the right-handed side are given by the following formula (6).

$$( \begin{matrix}\begin{matrix}d ( {θ}_{1} + π ) \\ ⋮\end{matrix} \\ d ( {θ}_{M} + π )\end{matrix} ) = ( \begin{matrix}{A}_{1 , 0} & … & {A}_{1 , deg} \\ ⋮ & ⋱ & ⋮ \\ {A}_{M , 0} & … & {A}_{M , deg}\end{matrix} ) ( \begin{matrix}\begin{matrix}{c}_{0} \\ ⋮\end{matrix} \\ {c}_{deg}\end{matrix} ) \qquad ( 5 )$$

$${A}_{m , n} = {( {θ}_{m} + π )}^{n} \qquad ( 6 )$$

The relative motion amount of a projection data is calculated from the projection data of the projection image and opposite data thereto. The projection data of the projection image and opposite data thereto are nearly identical to each other except for reversing, when there is no motion. Accordingly, the movement amount with the largest matching degree is set as the relative motion amount by examining which direction and how far data given by reversing the opposite data with respect to projection data is made to parallelly move or rotationally move and a matching degree at this time.

According to calculation of the relative motion amount, the calculation may be carried out from projection data of not the whole projection image but part of the projection image, and opposite data thereto. This is because the number of parameters in the motion model is finite, and thus the number of relative motion amounts needed to find the parameters may be calculated. Thus, calculation cost required for calculating the relative motion amounts can be reduced.

A formula obtained by specifically providing initial values of parameters in the motion model Δx(θ) is represented as a motion amount at an angle θ (0≤θ<π). A column vector obtained by arranging, in order, one given by adding each relative motion amount at θ calculated as described above to this is represented by D. An equation whose D is equal to the right-handed AC in the formula (5) is prepared. This becomes a fixed-point equation corresponding to the formula (3) according to the present embodiment.

The parameters in the motion model Δx(θ) can be determined by self-consistently solving the fixed-point equation. For example, a new fixed-point equation is prepared with initially determined C as values of parameters for finding the next motion amount, and the fixed-point equation can be self-consistently solved by further repeatedly solving the foregoing.

When repetitively determining parameters in the motion model Δx(θ) from the fixed-point equation, the parameters in the motion model are preferably determined based on the predetermined number of repetition times. In this manner, the parameters can be determined within a predetermined time.

Further, when repetitively determining parameters in the motion model Δx(θ) from the fixed-point equation, the parameters in the motion model are preferably determined based on a predetermined threshold value. For example, the threshold value can be set with respect to a residual square (index) of an initial Cₖ and a post-update Cₖ₊₁ in each step. In this manner, parameters with the predetermined accuracy can be determined.

An absolute movement amount is determined from the motion model Δx(θ) and the determined parameters, and thus the motion amount Δx(θ) at each rotation angle θ of the sample rotation axis can be calculated using the motion model Δx(θ) and the determined parameters to correct the projection image.

A method in the case of a parallel beam of X-rays is described as above, but in the case of a fan beam of X-rays, the relative motion amount cannot be calculated as it is. Accordingly, modifications in the case of the fan beam of X-rays are described as below.

The projection data of a projection image obtained in the case of the fan beam of X-rays is not made to be data to which opposite data strictly corresponds, for a magnification ratio. Then, fan/parallel-conversion for converting a projection image obtained by a fan beam method into a projection image acquired by a parallel beam method is carried out. Further, the fan/parallel-conversion with respect to the projection image in motion needs to be carried out after correcting the motion. Therefore, parameters as initial values are set by the motion model including the parameters, and the motion amount is calculated to correct (temporarily correct) the projection image using the calculated motion amount. The corrected projection image is subsequently fan/parallel-converted to calculate the relative motion amount.

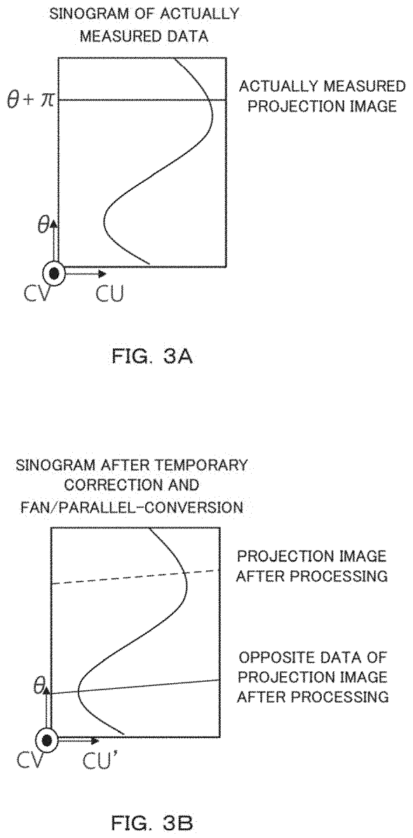

FIGS. 3A and 3B are schematic diagrams showing a sinogram of actually measured data as viewed on a CU-e plane before fan/parallel-conversion, and a sinogram as viewed on a CU-θ plane after temporary correction and fan/parallel-conversion, respectively. Each pixel of the projection image at an angle θ+π in FIG. 3A corresponds to pixels present on the cross section represented by a dotted line near the angle θ+π of the sinogram in FIG. 3B. The opposite position of each pixel of the projection image after fan/parallel-conversion is located on the cross section represented by a straight line near the angle θ in FIG. 3B. When temporarily calculating the motion amount, the coordinate position of each pixel of the projection image at the angle θ+π in FIG. 3A is temporarily shifted to compare matching degrees of a luminance value thereof and a luminance value of pixels on the straight line near the angle θ in FIG. 3B with each other. In this case, a temporary shift amount whose matching degree is highest is represented as a relative motion amount. Herein, in FIG. 3B, CU after fan/parallel-conversion is replaced with coordinates (CU′) on a virtual detection plane. The relative motion amount obtained by such a method is a relative amount from a sinogram near the angle θ at which the motion correction is made, and thus it is considered to be an absolute motion amount. Therefore, when preparing a fixed-point equation, Δx on the right-hand side of the formula (2) is set to 0.

When the projection image is an image obtained by the fan beam, the relative motion amount is found by the projection data that is fan/parallel-converted, and the opposite data thereto. In this manner, the relative motion amount is able to be calculated using fan/parallel-converted projection data. Accordingly, artifacts by motion can be corrected. That is, the present disclosure can be applied to the case of a tan beam of X-rays. In addition, in the case of a cone beam of X-rays as well, the cone beam can be regarded as a fan beam by setting a frame near a central cross section in CV direction of the projection image, and thus the present disclosure can be applied thereto.

Further, the following method is taken into account as another application method according to the present disclosure. In cases where artifacts by motion are generated when performing 180-degree scanning with a parallel beam, the present disclosure cannot be applied as it is. However, when an apparatus thereof can perform 360-degree scanning, the present disclosure can be applied by doing the following. First, 360-degree scanning is carried out in place of 180-degree scanning by reducing exposure time to a half, and doubling the projection number. Then, the motion according to the present disclosure is corrected, and the projection image by an amount equivalent to 130 degrees can be obtained by adding the opposite data thereinto.

Reconstructed images at the same noise level can be obtained while correcting motion, using such a method. Further, measuring time and reconstruction time are equivalent to those in the case of 180-degree scanning.

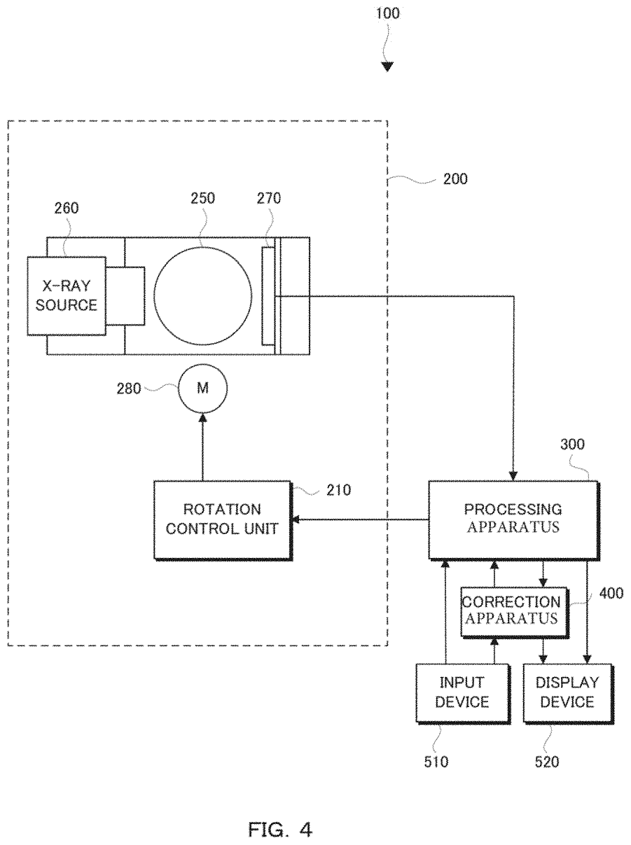

FIG. 4 is a schematic diagram showing the whole system 100 including a CT apparatus 200, and a processing apparatus 300, a correction apparatus 400, an input device 510 and a display device 520 that are connected thereto. Herein, the CT apparatus 200 as shown in FIG. 4 has a configuration in which a sample is rotated with respect to an X-ray source 260 and a detector 270, but may have a configuration in which a gantry obtained by integrating the X-ray source and the detector is rotated, without being limited thereto. Further, even if the CT apparatus 200 is an apparatus using any one of a parallel beam, a fan beam and a cone beam, it is usable. However, the 360-degree scanning needs to be performed even with any one of the beams.

The processing apparatus 300 connected to the CT apparatus 200 controls the CT apparatus 200, and processes acquired data. The correction apparatus 400 corrects projection images. The processing apparatus 300 and the correction apparatus 400 may be PC terminals, and may also be servers each on a cloud. The input device 510 that is, for example, a keyboard together with a mouse performs inputting into the processing apparatus 300 and the correction apparatus 400. The display device 520 that is for example, a display displays a projection image or the like thereon.

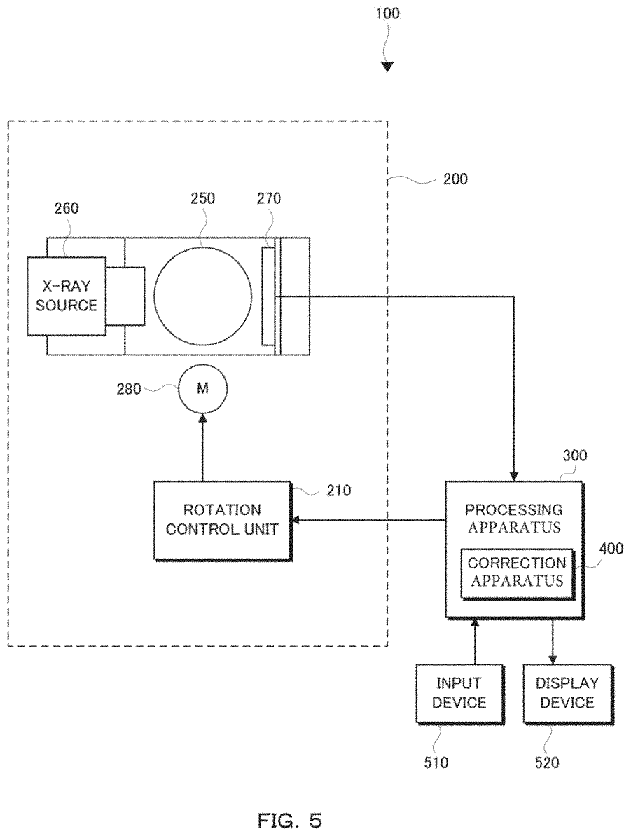

In addition, in FIG. 4, the processing apparatus 300 and the correction apparatus 400 are displayed as other constituent elements in order to emphasize a correction function of the correction apparatus 400, but as in FIG. 5, the correction apparatus 400 may be constituted as part of the function included in the processing apparatus 300, and may be constituted as one obtained by integrating the correction apparatus 400 and the processing apparatus 300. FIG. 5 is a schematic diagram showing a modified example of a configuration of the whole system. Cost for correcting artifacts by motion according to reconstruction of a CT image can be reduced by using such a system. Additionally, the functionality of the elements disclosed herein, including the processing apparatus 300 and/or the correction apparatus 400, may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

As shown in FIG. 4, the CT apparatus 200 comprises a rotation control unit 210, a sample stage 250, an X-ray source 260, a detector 270 and a drive section 280. A sample stage 250 arranged between the X-ray source 260 and the detector 270 is rotated to perform X-ray CT imaging. In addition, the X-ray source 260 and the detector 270 are arranged in a gantry, and the gantry may be rotated with respect to a sample fixed to the sample stage 250.

The CT apparatus 200 that drives the sample stage 250 in timing instructed by the processing apparatus 300 acquires a projection image of a sample. Measurement data is transmitted to the processing apparatus 300. The CT apparatus 200 is adapted to use precise industrial products such as semi-conductor apparatuses and so forth, but is also applicable to not only industrial apparatuses but also apparatuses for animals.

The X-ray source 260 irradiates the detector 270 with X-rays. The detector 270 provided with a light-receiving face for receiving X-rays is able to measure an intensity distribution of X-rays transmitted through a sample with a large number of pixels. The rotation control unit 210 rotates the sample stage 250 with the drive section 280 at set speed during CT imaging.

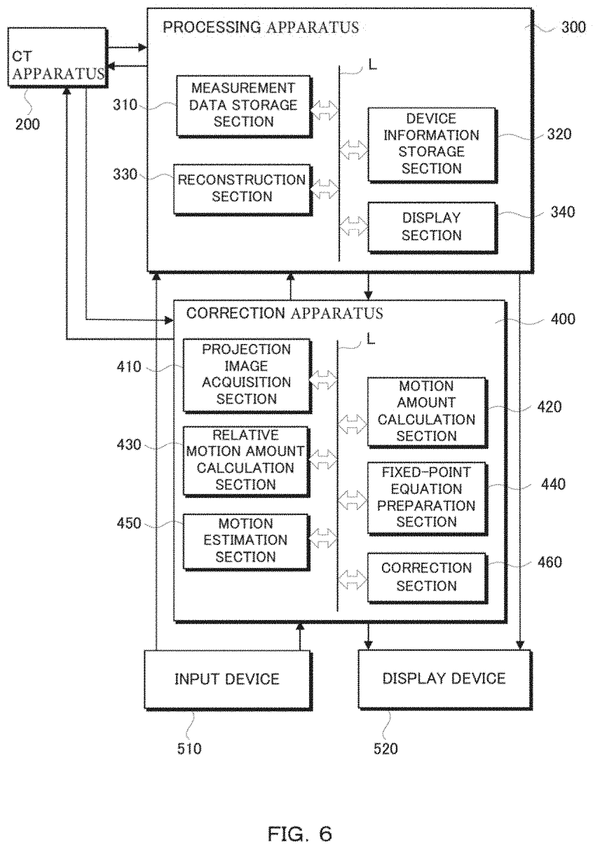

FIG. 6 is a block diagram showing a configuration of the processing apparatus 300 and the correction apparatus 400. The processing apparatus 3110 is constituted from a computer formed by connecting CPU (Central Processing Unit), ROM (Read Only Memory), RAM (Random Access Memory), and a memory to a bus. The processing apparatus 300 is connected to the CT apparatus 200 to receive information.

The processing apparatus 300 comprises a measurement data storage section 310, an apparatus information storage part 320, a reconstruction section 330, and a display section 340. Each section transmits and receives information with a control bus L. The input device 510 and the display device 520 is connected to CPU via an appropriate interface.

The measurement data storage section 310 stores measurement data acquired from the CT apparatus 200. The measurement data includes rotation angle information and a projection image corresponding thereto. The apparatus information storage part 320 stores apparatus information acquired from the CT apparatus 200. The apparatus information includes an apparatus name, beam shape, geometry during measurement, a scanning system, and so forth.

The reconstruction section 330 reconstructs a CT image from a projection image as an object. The display section 340 displays a reconstructed CT image and a projection image before/after correction on the display device 520. In this manner, a user can confirm the CT image based on the corrected projection image, and the projection image before/after the correction. Further, the user can instruct, and designate the processing apparatus, the correction apparatus or the like, based on the CT image and the projection image before/after the correction.

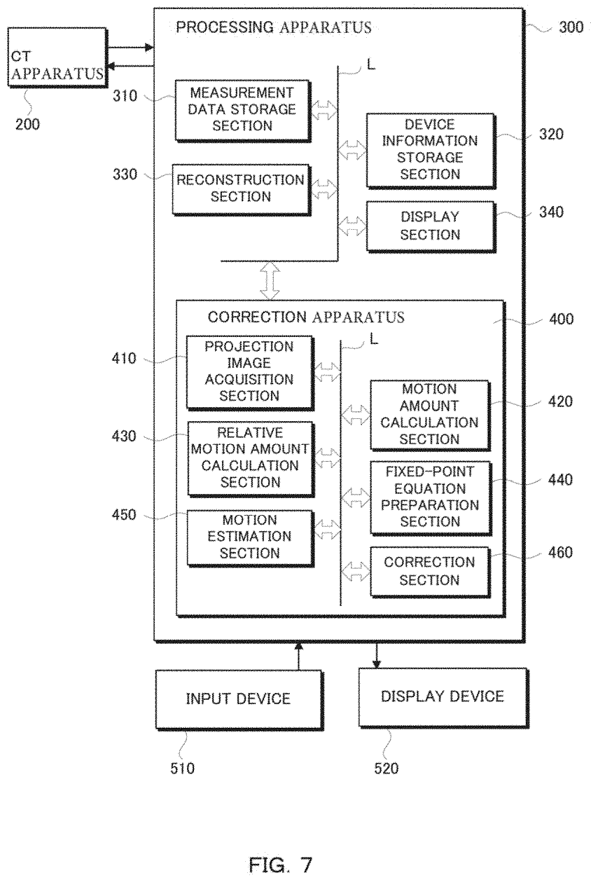

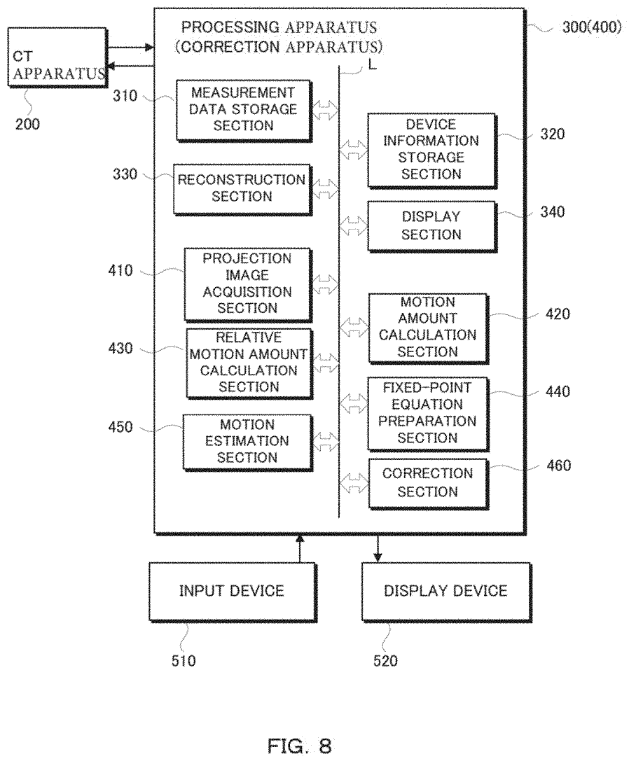

The correction apparatus 400 is constituted from a computer formed by connecting CPU, ROM, RAM and a memory to a bus. The correction apparatus 400 may be directly connected to the CT apparatus 200, and may be connected to the CT apparatus 200 via the processing apparatus 300. Further, the correction apparatus 400 may receive information from the CT apparatus 200, and may receive the information from the processing apparatus 300. In addition, it may be constituted as a function of part whose correction apparatus 400 is included in the processing apparatus 300, as shown in FIG. 7; and may be constituted as one obtained by integrating the correction apparatus 400 and the processing apparatus 300, as shown in FIG. 8. Further, the correction apparatus 400 may have part of a function of the processing apparatus 300.

The correction apparatus 400 comprises a projection image acquisition section 410, a motion amount calculation section 420, a relative motion amount calculation section 430, a fixed-point equation preparation section 440, a motion estimation section 450, and a correction section 460. Each section is able to transmit/receive information with a control bus L. When the correction apparatus 400 and the processing apparatus 300 are constituted from another configuration, the input device 510 and the display device 520 are also connected to CPU of the correction apparatus 400 via an appropriate interface. In this case, the input device 510 and the display device 520 may be different from those connected to the processing apparatus 300.

The projection image acquisition section 410 acquires a projection image of 360-degree scanning from the CT apparatus 200 and the processing apparatus 300. The projection image may be an image obtained by any one of a parallel beam, a fan beam, and a cone beam.

The motion amount calculation section 420 that sets a motion model including parameters calculates a motion amount based on the motion model. According to the motion model, the functional form is stored in advance. Further, an arbitrarily settable configuration may be provided by user's selecting correction objects (translation CU: Δx, translation CV: Δz, and rotation: Δϕ), functional forms (power series and Fourier series), and the maximum degree (the maximum number of terms). In this manner, the number of motion models and the number of estimated parameters can be arbitrarily determined. The motion model may be determined in advance. According to parameters for calculating an initial motion amount, designation thereof may be made by the user. Further, there may be provided a configuration in such a manner that the motion amount is calculated with initial parameters as all zeroes. The motion amount calculation section 420 calculates a motion amount that is corrected (correction amount) by using a model for which parameters determined by the motion estimation section 450 are substituted.

The relative motion amount calculation section 430 calculates the relative motion amount of the projection data from the projection data of the projection image, and opposite data thereto. The relative motion amount calculation section 430 preferably calculates the relative motion amount of the projection data, based on a matching degree between the projection data and the opposite data. When the projection image is an image acquired by a fan beam or a cone beam, the relative motion amount calculation section 430 calculates the relative motion amount from a projection data and an opposite data thereto by fan/parallel-converting the acquired projection image thereinto.

According to calculation of the relative motion amount, the calculation may be carried out from projection data of not the whole projection image but part of the projection image, and opposite data thereto. In this case, for example, it is made possible to calculate the relative motion amount from the projection image for every ten projections, and so forth. Setting of the number of pieces of opposite data used for calculation (the number of sets) is set as a configuration arranged by a user. Further, it may be set as a configuration that is automatically set by a computer, based on the degree of the motion model. Further, it may be predetermined.

According to calculation of the relative motion amount, the calculation may be carried out based on an area of part of the projection data of the projection image and another area of part of the opposite data thereto. Setting of the partial area of the projection data is set as a configuration arranged by a user. For example, the area can be set by designating a center position between a width and a frame in in each of CU direction and CV direction. Further, it may be set as a configuration that is automatically set by a computer, based on a characteristic structure. Further, it may be predetermined.

The fixed-point equation preparation section 440 prepares a fixed-point equation for determining parameters in a motion model. The fixed-point equation is prepared according to the number of set motion models. For example, when the motion model indicates translation in CU direction of a sample rotation axis, setting is made by calculating d(θ+π) with respect to rotation angles θ of a plurality of sample rotation axes from the relative motion amount r(θ) calculated by the relative motion amount calculation part, and the motion amount Δx(θ) calculated by the motion amount calculation part. The matrix A using a coefficient of each parameter at rotation angle (θ+π) of a sample rotation axis in the motion model as an element is automatically set by determining a functional form for a rotation angle and a motion model.

The motion estimation section 450 determines parameters in the motion model by self-consistently solving the fixed-point equation. Provided may be a configuration of outputting the determined parameters to the motion amount calculation section 420.

The correction section 460 corrects a projection image using the motion amount (correction amount) calculated by the motion amount calculation section 420. The motion with respect to the projection image can be corrected in this manner. A corrected projection image that is output by the reconstruction section 330 is converted into the CT image. When the projection image is an image acquired by a fan beam or a cone beam, the corrected projection image that is output to the relative motion amount calculation section 430 may be used for calculating the relative motion amount after fan/parallel-conversion.

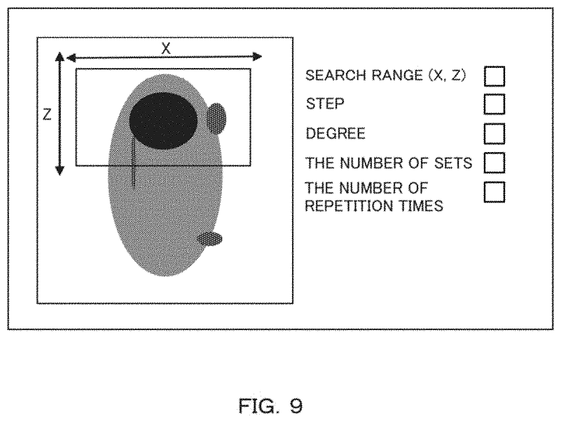

When the above-described setting is designated by a user, for example, a UI function with which various kinds of setting can be made by a mouse operation and a keyboard operation are preferably used. FIG. 9 is a conceptual diagram showing one example of UI when a user performs various kinds of setting. In an example of FIG. 9, for example, a frame for calculating a matching degree with an image of opposite data can be set on a display screen of certain projection data displayed on the left-hand side of the screen.

According to a search range, how much the frame in the left figure is moved in the up-and down and right-and left directions can be set. As to the step, the size to move the frame for calculating the matching degree can be set. As to the degree, the maximum degree of the motion model can be set. As to the number of sets, the number of sets of projection data and opposite data that are used for calculation can be set. As to the number of repetition times, the number of repetition times when repetitively solving the fixed-point equation can be set. In addition, setting items displayed in FIG. 9 are one example, and thus even when these are set by a user, it may be made possible to set only part of these, and it may be made possible to set all of them. Further, provided may be setting items that are not displayed in FIG. 9.

### [Measuring Method]

A sample is arranged in the CT apparatus 200, and movement of a rotation axis and projection of X-rays are repeated under the predetermined condition to obtain a projection image while irradiating the sample with X-rays. The CT apparatus 200 transmits information of an apparatus such as a scanning system and an acquired projection image as measurement data to the processing apparatus 300 or the correction apparatus 400.

### [Correction Method]

### (Explanation of Flow in the Case of Parallel Beam)

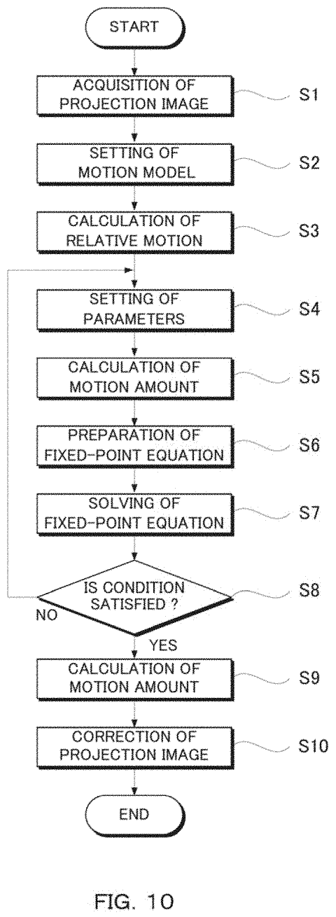

FIG. 10 is a flowchart showing one example of an operation of a correction apparatus 400. First, the correction apparatus 400 acquires a projection image (Step S1). Next, a motion model is set (Step S2). Next, a relative motion amount is calculated (Step S3). Sets of opposite data are acquired at a plurality of designated angles, and a predetermined amount for the opposite data is moved at each angle to set a movement amount for which a matching degree of these becomes highest as a relative motion amount. When setting a frame for the projection image, the matching degree is calculated only by an area in a frame. Next, parameters in the motion model are set (Step S4). Herein, initial parameters may be all zeroes. Further, when there are parameters designated and estimated as initial parameters, they may be used. Next, the motion amount is calculated using set parameters (Step S5). Next, a fixed-point equation is prepared (Step S6). The motion amount and the relative motion amount calculated at each rotation angle θ are added, and substituted for the left-hand side. There equations are arranged in the form of a matrix to prepare the fixed-point equation. Next, the fixed-point equation is solved (Step S7). The parameters in the motion model can be estimated by self-consistently solving the fixed-point equation.

Then, when not satisfying the set condition (Step S8-No), estimated parameters are set after returning to Step S4, and the processing up to Step S7 is performed again. On the other hand, when satisfying the set condition (Step S8-Yes), the motion amount (correction amount) is next calculated from the estimated parameters (Step S9). Then, the projection image is corrected using the estimated motion amount (correction amount) (Step S10). In this manner, the projection image can be corrected. In addition, according to acquiring of the projection image, and setting of the motion model, it does not matter which one is performed first.

### (Explanation of Flow in the Case of Fan Beam)

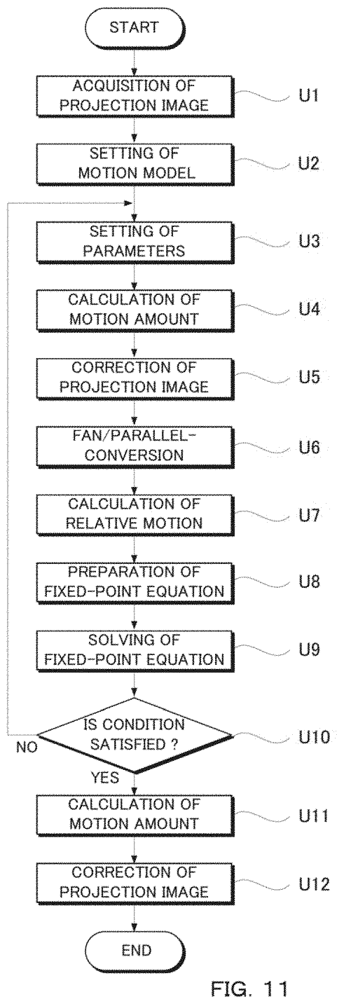

FIG. 11 is a flowchart showing a modified example of an operation of a correction apparatus 400. FIG. 11 shows one example of the operation when correcting a projection image acquired with a tan beam. First, the correction apparatus 400 acquires a projection image (Step U1). Next, the motion model is set (Step U2). Next, parameters in the motion model are set (Step U3). Herein, initial parameters may be all zeroes. When there are parameters designated or estimated as initial parameters, they may be used. Next, the motion amount is calculated using the parameters (Step U4). Next, the projection image is corrected using the motion amount (Step U5). Next, a sinogram is fan/parallel-converted (Step U6). Next, the relative motion amount is calculated (Step U7). The projection image of opposite data is moved by a predetermined amount to set the opposite data according to a corrected sinogram, and the movement amount whose matching degree is highest as a relative motion amount. When setting a frame for the projection image, the matching degree is calculated only by an area in a frame. Next, a fixed-point equation is prepared (Step U8). Next, the fixed-point equation is solved (Step U9). The parameters in the motion model can be estimated by self-consistently solving the fixed-point equation.

Then, when not satisfying the set condition (Step U10-No), estimated parameters are set after returning to Step U3, and the processing up to Step U9 is performed again. On the other hand, when satisfying the set condition (Step U10-Yes), the motion amount (correction amount) is next calculated from the estimated parameters (Step U11). Then, the projection image is corrected using the estimated motion amount (correction amount) (Step U12). In this manner, the projection image can be corrected even with the projection image acquired with the fan beam. In addition, similarly to those described above, according to acquiring of the projection image and setting of the motion model, it does not matter which one is performed first.

In addition, according to conditions in the step in S8, and the step in U10, whether or not the number of loop repetition times and the determined parameters satisfy predetermined threshold values, and so forth can be set as conditions.

### [Correction and Reconstruction Method]

Flowcharts in FIGS. 10 and 11 each show an operation of only a correction apparatus 400. This is good enough as correction of the projection image, but in order to clarify the difference from conventional techniques, an operation including measurement and reconstruction of the projection image is also described.

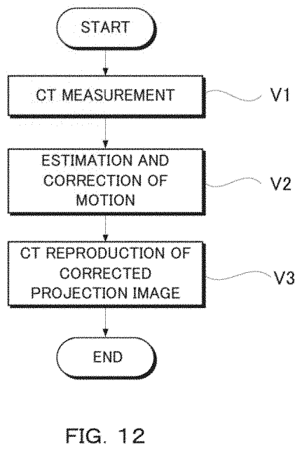

FIG. 12 is a flowchart showing one example of an operation of a system 100. First, the CT apparatus 200 performs CT measurement (Step V1). The CT measurement includes repetition of movement of a rotation axis and projection of X-rays. Next, the motion is estimated and corrected (Step V2). As to a flow by which the motion is estimated, for example, one of the flows in FIG. 10 and FIG. 11 may be used according to kinds of optical system for the acquired projection image. Further, the optical system is identified from apparatus information, and it may be made possible to select a suitable flow. Then, the processing apparatus 300 or the correction apparatus 400 reconstructs a CT image, using the corrected projection image (Step V3). In this manner, the reconstructed CT image can be acquired using the projection image that has been corrected.

In the conventional techniques, the reconstruction of CT images and correction for reducing artifacts have been repeated. In contrast, according to the present disclosure, correction for reducing artifacts is made to the projection image before the reconstruction. In this manner, cost required for correction can be reduced.

### Example 1

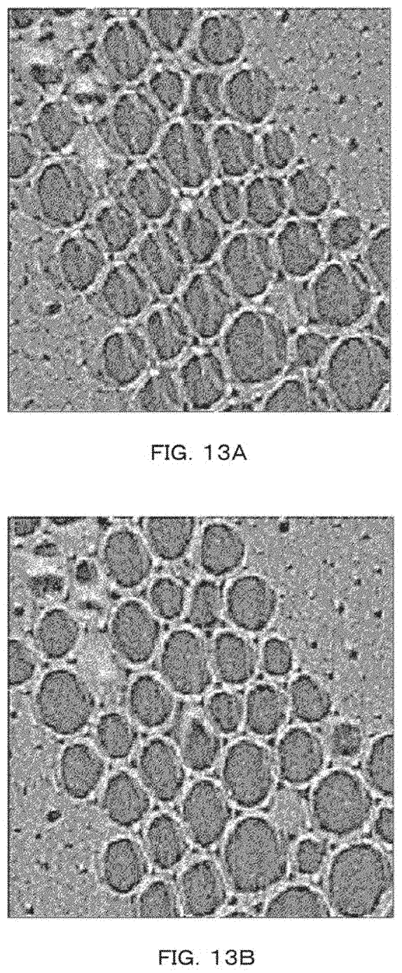

The cross section of a bamboo stick (sample 1) is observed using the system 100 constituted as described above. The measurements are performed with the CT apparatus 200, using Rigaku Corp. nano3DX (parallel beam). FIGS. 13A and 13B are a CT image of sample 1, that is reconstructed using a projection image that is not corrected; and another CT image of the sample 1, that is reconstructed using a projection image that is corrected, respectively. A FDK method is used for reconstruction.

It is found out by correction thereof that the artifacts are reduced, by comparing FIG. 13A with FIG. 13B.

### Example 2

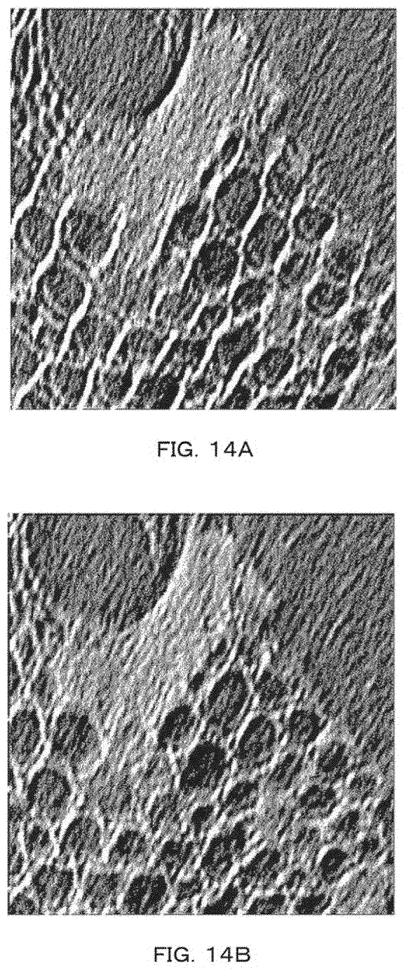

Next, the cross section of another bamboo stick (sample 2) is observed. The measurements are performed with the CT apparatus 200, using Rigaku Corp. HX (fan beam). FIGS. 14A and 14B are a CT image of sample 2, that is reconstructed using a projection image that is not corrected; and another CT image of the sample 2, that is reconstructed using a projection image that is corrected, respectively. As is the case with the sample 1, the FDK method is used for reconstruction.

It is found out by correction thereof that the artifacts are reduced, by comparing FIG. 14A with FIG. 14B. It can be confirmed that the correction method according to the present disclosure is applicable to the projection image measured with the fan beam.

It is confirmed from those described above that a correction apparatus according to the present disclosure, a system, a method and a program are able to effectively correct artifacts by motion according to reconstruction of the CT image, thereby being able to reduce calculation cost.

The present disclosure is not limited to only the above-described embodiments, which are merely exemplary. It will be appreciated by those skilled in the art that the disclosed systems and/or methods can be embodied in other specific forms without departing from the spirit of the disclosure or essential characteristics thereof. The presently disclosed embodiments are therefore considered to be illustrative and not restrictive. The disclosure is not exhaustive and should not be interpreted as limiting the claimed invention to the specific disclosed embodiments. In view of the present disclosure, one of skill in the art will understand that modifications and variations are possible in light of the above teachings or may be acquired from practicing of the disclosure.

Reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The scope of the invention is indicated by the appended claims, rather than the foregoing description.

1. A correction apparatus for correcting artifacts by motion during measurement of a CT image, the correction apparatus comprising:
circuitry configured to
acquire a projection image of 360-degree scanning;
determine a motion amount using parameters by setting a motion model including the parameters;
determine a relative motion amount of a projection data from the projection data of the projection image and opposite data thereto;
determine the parameters in the motion model by self-consistently solving a fixed-point equation, the fixed-point equation including the motion amount and the relative motion amount; and
correct the projection image using the motion amount.

2. The correction apparatus according to claim 1,
wherein the projection image is an image obtained by a fan beam, and the relative motion amount is found by the projection data that is fan/parallel-converted and opposite data thereto.

3. The correction apparatus according to claim 1,
wherein the motion model is a model for expressing at least one or more of translation of a sample rotation axis on a detector plane or rotation around a certain axis.

4. The correction apparatus according to claim 1,
wherein the motion model is expressed by a finite-order polynomial in which a rotation angle of the sample rotation axis is a variable.

5. The correction apparatus according to claim 1,
wherein the circuitry is further configured to determine the parameters in the motion model based on a predetermined number of repetition times.

6. The correction apparatus according to claim 1,
wherein the circuitry is further configured to determine the parameters in the motion model based on a predetermined threshold value.

7. The correction apparatus according to claim 1,
wherein determining the relative motion amount is based on an area of part of the projection data.

8. The correction apparatus according to claim 1, wherein the circuitry is further configured to
generate the CT image by performing reconstruction based on the projection image corrected by the correction section, and
display the CT image on a display device.

9. A system, comprising:
a computational tomography (CT) scanner, wherein the CT apparatus includes circuitry configured to
acquire a projection image of 360-degree scanning,
determine a motion amount using parameters by setting a motion model including the parameters,
determine a relative motion amount of a projection data from the projection data of the projection image and opposite data thereto,
determine the parameters in the motion model by self-consistently solving a fixed-point equation, the fixed-point equation including the motion amount and the relative motion amount, and
correct the projection image using the motion amount,
wherein the CT scanner includes an X-ray source that generates X-rays, a detector that detects the X-rays, and the circuitry is further configured to control rotation of a sample or the X-ray source and the detector.

10. A method for correcting artifacts by motion during measurement of a CT image, the method comprising:
acquiring a projection image of 360-degree scanning;
determining a motion amount using parameters by setting a motion model including the parameters;
determining a relative motion amount of a projection data from the projection data of the projection image and opposite data thereto;
determining the parameters in the motion model by self-consistently solving a fixed-point equation, the fixed-point equation including the motion amount and the relative motion amount; and
correcting the projection image using the motion amount.

11. A non-transitory computer readable recording medium having recorded thereon a program for correcting artifacts by motion during measurement of a CT image, the program causing a computer to execute the processes of:
acquiring a projection image of 360-degree scanning;
determining a motion amount using parameters by setting a motion model including the parameters;
determining a relative motion amount of a projection data from the projection data of the projection image and opposite data thereto;
determining the parameters in the motion model by self-consistently solving a fixed-point equation, the fixed-point equation including the motion amount and the relative motion amount; and
correcting the projection image using the motion amount.
